(19) United States
(12) Patent Application Publication
(10) Pub. No.: US 2003/0063710 A1
(43) Pub. Date: Apr. 3, 2003

(54) Subscriber line terminal and method for fault detection in the power supply

(76) Inventors: Rolf Berthe, Germering (DE); Gerhard Prey, Eichenau (DE); Peter Semmler, Moosburg (DE)

Correspondence Address: Morrison & Foerster LLP, Suite 300, 1650 Tysons Boulevard, McLean, VA, 22102, US

(21) Appl. No.: 10/190,598

(22) Filed: Jul. 9, 2002

(30) Foreign Application Priority Data
Jul. 9, 2001 (DE) 10133289.0

(51) Int. Cl. H04M 1/24

(52) U.S. Cl. 379/1.01

(57) ABSTRACT

The invention relates to a subscriber line terminal and a method for fault detection in the power supply having a multiplicity of subscriber line modules and at least one power supply. The subscriber line modules are supplied with reference to at least one voltage level used in the electronic system via at least two useful voltage bus lines, and the at least two useful voltage bus line are fed by at least two parallel-connected power supply units which simultaneously supply the two useful voltage bus lines in each case, at least one feedback of the voltage from the useful voltage bus line being provided per power supply unit.

### CLAIM FOR PRIORITY

This application claims priority to German application number 10133289.0 filed Jul. 9, 2001.

### TECHNICAL FIELD OF THE INVENTION

The invention relates to a subscriber line terminal, and in particular, to a subscriber line terminal having a multiplicity of subscriber line modules and at least one power supply.

### BACKGROUND OF THE INVENTION

Subscriber line terminals are used, for example, in electronic dialling system (EWSD). In the case of these subscriber line terminals, it is necessary to be able to manage the highest incidence of load to be expected. On the other hand, the aim is to ensure by means of a common supply of a plurality of subscriber line modules for using a so-called pool of power supply units that the statistical fluctuation in the load ranges does not turn out excessively high, such that no unnecessary number of power supply units need be pre-connected. In practice, for example, use has been made of one power supply unit per 4 to 8 subscriber line modules, such that in the case of a subscriber line terminal of type D with 16 ports per SLM the supply of 64 for 128 ports is taken over by one power supply unit (DCC). Consequently, the power supply unit is dimensioned such that it can support not only the average traffic (e.g., in the case of 128 ports and a usage of 0.1 Erlang, then approximately 13 ports), but also peak loads or unbalanced loading. Hence, even if the DLU (subscriber line terminal) has 100 calls active overall for approximately 1000 ports, the calls can be precisely in the region of the power supply unit. It would therefore be favorable to have a power supply unit that can supply all active ports. However, this would result in an excessively large design and, in the case of a fault, the active range of the fault would become excessively wide. Consequently, a pool is created which has a plurality of power supply units and in the case of which an individual power supply unit covers approximately 150 active ports. Thus, with 3 power supply units, it is possible to supply approximately 450 ports. However, since in the event of failure of a power supply unit only 300 run, one power supply unit is held in reserve, thus resulting in an n+1 redundancy. Overall, four power supply units (3+1) are then required for the so called DLUG with 2000 ports (approximately 62 modules per 32 ports).

Thus, a pool of power supply units which suffices to cover an instance of high loading occurring with a certain probability is created in the subscriber line terminal. A further power supply unit is also added in order to achieve a simple failure redundancy (n+1).

One problem in this design, with a pool of power supply units, resides in unambiguously detecting the failure of a power supply unit and simultaneously unambiguously locating the power supply unit. Furthermore, the system is intended not to fail given a malfunction in a power supply unit. This fact is particularly relevant when a single power supply unit at the output has a short circuit to 0 volts, which would then put the bus completely out of operation.

### SUMMARY OF THE INVENTION

In one embodiment of the invention, there is a subscriber line terminal having a multiplicity of subscriber line modules and at least one power supply. The subscriber line modules are supplied with reference to at least one voltage level used in the electronic system via at least two useful voltage bus lines, and the at least two useful voltage bus lines being fed by at least two parallel-connected power supply units (DCC) which simultaneously supply the two useful voltage bus lines in each case.

In another embodiment of the invention, there is a method for fault detection and fault locating in the power supply in a subscriber line terminal.

In still another embodiment of the invention, a subscriber line terminal has a pool of power supply units to the effect that the defective power supply unit can be detected and located unambiguously, and there is protection against failure.

In yet another embodiment of the invention, there is a method for fault detection and location for such a power supply unit.

In another embodiment of the invention, the subscriber line terminal (DLU) has a multiplicity of subscriber line modules (SLMx) and at least one power supply, the subscriber line modules (SLMx) being supplied with reference to at least one voltage level finally used in the electronic system via at least two useful voltage bus lines, and the at least two useful voltage bus lines being fed by at least two parallel-connected power supply units (P-DCCx) which simultaneously supply the two useful voltage bus lines in each case, to be improved to the effect that at least one feedback of the voltage from the useful voltage bus line is provided per power supply unit (P-DCCx).

Owing to this feedback of the voltage from the voltage bus lines, it is possible, in the case of an appropriate connection of the power supply units, of detecting whether or in which of the power supply units a fault has occurred.

It is preferable that each power supply unit has disconnecting elements per voltage bus line for controlled and individual electrical disconnection of the power supply units of the at least two voltage bus lines. Such disconnecting elements can be, for example, controlled switches that are actuated by a controller at a higher level than the n power supply units.

In another aspect according to the invention, the units connected to the at least two voltage bus lines have means for electrical decoupling of the useful voltage bus lines. This preferably means diodes arranged with their direction corresponding to the flow of current and which are inserted into each connection to the bus lines.

According to the invention, in the subscriber line terminal, at least one voltage monitoring unit can be provided for at least one of the voltage bus lines, it being preferred to provide in each of the at least two power supply units a voltage monitoring unit for at least each one of the fed-back voltage bus lines.

In still another aspect, control and monitoring lines are provided between a higher-level control and monitoring unit, on the one hand, and the disconnecting elements and voltage monitoring units, on the other hand. It is thereby possible in a simple way to coordinate centrally the switching on and off of the power supply units of the at least one useful voltage bus line that is used for testing the power supply units.

In another embodiment according to the invention, the subscriber line terminal provides that the subscriber line modules provided therein in each case have at least one dedicated voltage transformer for the dedicated supply of low voltage, and supply with the higher voltage values is provided via the at least two useful voltage bus lines. According to the invention, a low voltage here is to be taken as a range of between +/−10 V, preferably between +/−5 V, preferably at 1.8 and 5 volts. No pool principle is possible for these voltages, since the voltage drop in the decoupling elements is impermissibly high.

In another embodiment of the invention, one power supply line, preferably with separate fusing and/or separate voltage monitoring, is made available in each case for each of the at least two power supply units. It is preferable to provide n fuses for n power supply units so that one power supply is effected by failure of a fuse. At the same time, or as an alternative, it is also possible to provide two additional power supply buses, preferably with separate fusing, per bus and/or separate voltage monitoring unit, for the low voltage generation of the subscriber line modules. This is advantageous, since the voltage transformers for low voltages do not operate in the pool, and thus it is impossible to implement pool redundancy. Consequently, the individual low voltage power supply units are themselves supplied redundantly. It is also possible to provide an individual fuse for each, but the outlay would rise here. Thus, it is preferred to assign two fuses per SLM group. A group includes in the case of the DLUG of up to 32 SLMs, e.g. 1024 ports.

In accordance with another embodiment of the invention, the method for fault detection and fault locating in the power supply in a subscriber line terminal preferably has the above-described features. In an alternative embodiment, during a test phase, a voltage bus line is fed by one of the power supply units present, while the other power supply units are disconnected electrically from this one voltage bus line, and the voltage present on the voltage bus line is tested via a voltage monitoring unit in order thereby to check the operability of this power supply unit.

According to the invention, the method can be carried out sequentially for power supply units present such that fault location process is carried out at specific time intervals. Of course, an appropriate message is sent to the monitoring unit after detection of a fault.

In addition to the checking of the power supply units, it is also possible to check the power supply of the power supply units themselves, such that it can be located unambiguously whether a fault is present at the power supply unit or on the feed line. An appropriate check can likewise be provided in the power supply for the low voltage generation of the subscriber line modules.

### BRIEF DESCRIPTION OF THE DRAWINGS

The invention is described below in more detail with reference to an exemplary embodiment with the aid of a figure.

FIG. 1 illustrates an example according to the invention of a characteristic part of a subscriber line terminal.

### DETAILED DESCRIPTION OF THE PREFERRED EMBODIMENTS

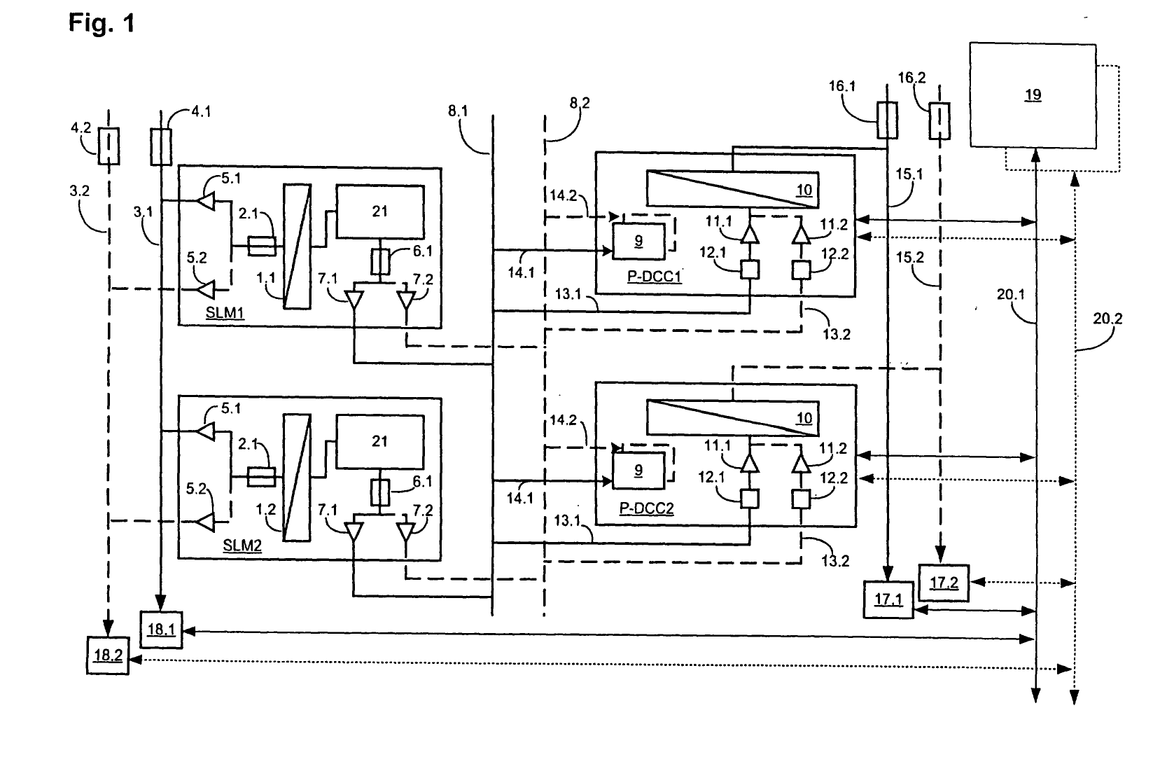

FIG. 1 illustrates two subscriber line modules SLM1, SLM2 and, furthermore, two power supply units P-DCC1, P-DCC2. Up to 122 SLMs are interconnected in the real design.

As known from the prior art, the subscriber line modules each have an on-board voltage transformer 1.1 and 1.2 for the low voltages (here 5, 3.3 and 1.8 volts) with which the electronic system of the SLMx 21 is supplied with reference to its low voltage. The on-board voltage transformers 1.x are fused in each case by a fuse 2.1 and 2.2 relative to the two supply bus lines 3.1 and 3.2, one fuse preferably attending to a collective of SLMs. This amounts to 32 items in the case of a DLU of type G (DLUG). Located between the fuses 2.x and the two power supply lines 3.x are two diodes 5.x, which ensure electrical decoupling of the in each the two power supply lines.

Also illustrated in the subscriber line terminal are two power supply units P-DCC1 and P-DCC2 which, in a pool, via the two useful voltage bus lines 8.1 and 8.2, supply high voltage to the subscriber line modules SLMx connected thereto, i.e. absolute voltage values greater than 10 V. The subscriber line modules SLMx receive their voltage from these voltage buses 8.1 and 8.2 fused via in each case one fuse 6.1 and 6.2, with a diode 7.1 and 7.2 that ensures that the two voltage bus lines 8.1 and 8.2 are electrically decoupled being arranged in each case in the supply leads.

The voltage bus lines 8.1 and 8.2 are supplied by the power supply units P-DCC1 and P-DCC2 via the supply leads 13.1 and 13.2, which are again respectively electrically decoupled internally with the aid in each case of one diode per bus 11.1 and 11.2. The voltage itself is generated in the voltage transformers 10 from the incoming supply voltage. Provided for feeding the supply voltage are two supply lines 15.1 and 15.2 that are respectively fused separately via a fuse 16.1 and 16.2. It is preferred to use one fuse per power supply unit P-DCCx, in order to ensure the n+1 redundancy.

Arranged in a bus line, at the output of the two power supply units, are a switch 12.1 and 12.2 that can be controlled via a control and monitoring unit (not shown here). The voltage present on the useful voltage bus lines 8.1 and 8.2 is additionally fed back via the lines 14.1 and 14.2 to a voltage monitoring unit 9 that is arranged here, by way of example, on the voltage supply units. It is possible as a result to achieve optimum monitoring per power supply unit and also per bus, with the process of searching for faults or fault locations being unambiguous.

According to the invention, the power supply units P-DCCx operating in the pool can be arbitrarily disconnected or connected by the voltage bus lines 8.1 and 8.2 with the aid of the switches 12.1 or 12.2 that can be controlled by a monitoring and control unit.

In conjunction with the diodes 7.1 and 11.1 or 7.2 and 11.2, which decouple the two useful voltage bus lines electrically, the power supply units can be coupled to the useful voltage bus lines such that, on the one hand, the full load is available on one of the voltage bus lines by coupling the power supply units, while a single power supply unit P-DCC is coupled on the other bus 8.2. It is now possible through the feedback of the voltage of the respective bus to the voltage monitoring unit 9 to measure the generated voltage of the power supply unit now currently and solely connected to one bus system and to detect the operability of said power supply unit.

This method can then be applied successively for power supply units P-DCCx located in the pool such that the power supply units are tested individually. At the same time, however, the power supply, which is performed via the respective other bus by the power supply units P-DCCx is maintained, and so no interruption takes place. That is, the pool provides its power.

Owing to the individual testing of the power supply units and an acknowledgement to the monitoring and control unit, it is then also possible to locate exactly a possible fault and the power supply unit associated therewith. It is thereby possible to demarcate a fault that can come about on the way from the fuse to the power supply unit P-DCCx, because if the P-DCCx no longer operates this could be because of the fuse or the P-DCCx. The extra monitoring delimits this.

In the example illustrated in FIG. 1, there is provided in each case, in addition, for the two redundantly designed power supply buses 3.1 and 3.2 and the power supply lines 15.1 and 15.2 an additional voltage monitoring unit 17.1, 17.2 or 18.1, 18.2, which additionally also detect a possible failure of one of the two bus systems or one strand of the two bus systems, and likewise feeds it back to the monitoring and control unit 19—which is likewise configured redundantly.

The voltage bus lines 8.1 and 8.2 illustrated by way of example have been shown with the inclusion of their feeding and outgoing lines per operating voltage used, and there are a number of them in real designs corresponding to the number of the operating voltages required (for example +42 V and −65 V).

The above-named features of the invention can be used not only in the respectively specified combination, but also in other combinations or on their own, without exceeding the scope of the invention, for example more SLMs, more pool DCC and, also more than one voltage per pool DCC.

What is claimed is:

1. A subscriber line terminal, comprising:
a plurality of subscriber line modules and at least one power supply, wherein
the subscriber line modules supplied with reference to at least one voltage level used in an electronic system via at least two voltage bus lines, and
the at least two voltage bus lines fed by at least two parallel-connected power supply units which simultaneously supply the two voltage bus lines, and
at least one feedback of the voltage from the voltage bus line is provided per power supply unit.

2. The subscriber line terminal as claimed in claim 1, wherein each power supply unit has disconnecting elements per voltage bus line for controlled and individual electrical disconnection of the at least two voltage bus lines.

3. The subscriber line terminal as claimed in claim 1, wherein units connected to the at least two voltage bus lines have a device for electrical decoupling the voltage bus lines.

4. The subscriber line terminal as claimed in claim 1, further comprising at least one voltage monitoring unit provided for at least one of the voltage bus lines.

5. The subscriber line terminal as claimed in claim 4, wherein at least one voltage monitoring unit for at least one fed-back voltage bus line is provided in each of the at least two power supply units.

6. The subscriber line terminal claim 1, wherein control and monitoring lines are provided between one of a higher-level control and monitoring unit and the disconnecting elements and voltage monitoring units.

7. The subscriber line terminal as claimed in claim 1, wherein the subscriber line modules have at least one dedicated voltage transformer for dedicated supply with low voltage, and the higher voltage values are supplied via the at least two voltage bus lines.

8. The subscriber line terminal as claimed in claim 1, wherein one power supply line is provided in each case for each of the at least two power supply units.

9. The subscriber line terminal as claimed in claim 1, further comprising two additional parallel-connected power supply buses provided for the low voltage generation of the subscriber line modules.

10. A method for fault detection and fault locating in a power supply in a subscriber line terminal, comprising:
supplying subscriber line modules with reference to at least one voltage level used in an electronic system via at least two voltage bus lines, and
the at least two voltage bus lines fed by at least two parallel-connected power supply units which simultaneously supply the two voltage bus lines, and
at least one feedback of the voltage from the voltage bus line is provided per power supply unit, wherein
during a test phase, a voltage bus line is fed by one of the power supply units, and the other power supply units are disconnected electrically from this one voltage bus line, and the voltage present on the voltage bus line is tested via a voltage monitoring unit to check the operability of the power supply unit.

11. The method as claimed in claim 10, wherein the method is carried out sequentially for the power supply units.

12. The method as claimed in claim 10, wherein the power supplies of the power supply units are monitored.

13. The method as claimed in claim 10, wherein the power supplies for the low voltage generation of the subscriber line modules are monitored.

14. The subscriber line terminal as claimed in claim 2, wherein units connected to the at least two voltage bus lines have a device for electrical decoupling the voltage bus lines.
